(19) United States
(12) Patent Application Publication
(10) Pub. No.: US 2010/0027278 A1
(43) Pub. Date: Feb. 4, 2010

(54) Light accommodator

(76) Inventor: Leroy Russell Bohne, Gillette, WY (US)

Correspondence Address: Leroy Russell Bohne, 803 Vivian Ct, Gillette, WY, 82718-6100, US

(21) Appl. No.: 12/231,194

(22) Filed: Aug. 30, 2008

Related U.S. Application Data
(60) Provisional application No. 61/125,331, filed on Apr. 23, 2008.

(51) Int. Cl. F21V 21/08; F21V 21/00

(52) U.S. Cl. 362/396; 362/382

(57) ABSTRACT

Being versatile in application, can be hung and used anywhere where a 120 volt UL approved J-Box and cord are needed.

Light Accommodator allows any 120 volt light configuration to be mounted permanently to it by means of its UL approved J-Box and cord.

I have invented a new design for a Light Accommodator as set forth in the following specification:

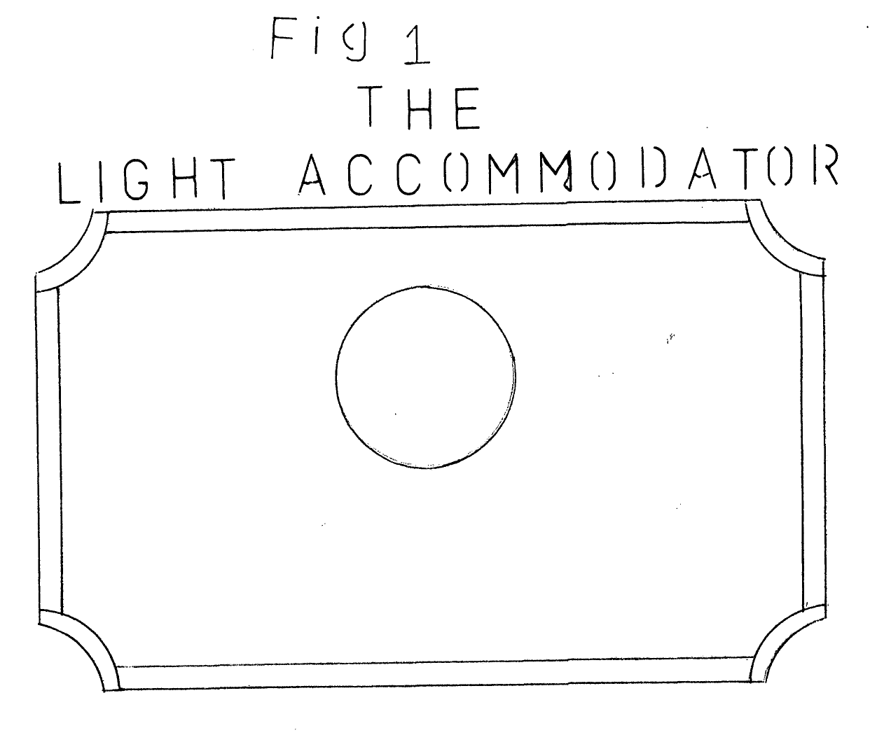

FIG. 1 is a front view of a LIGHT ACCOMMODATOR showing my new design;

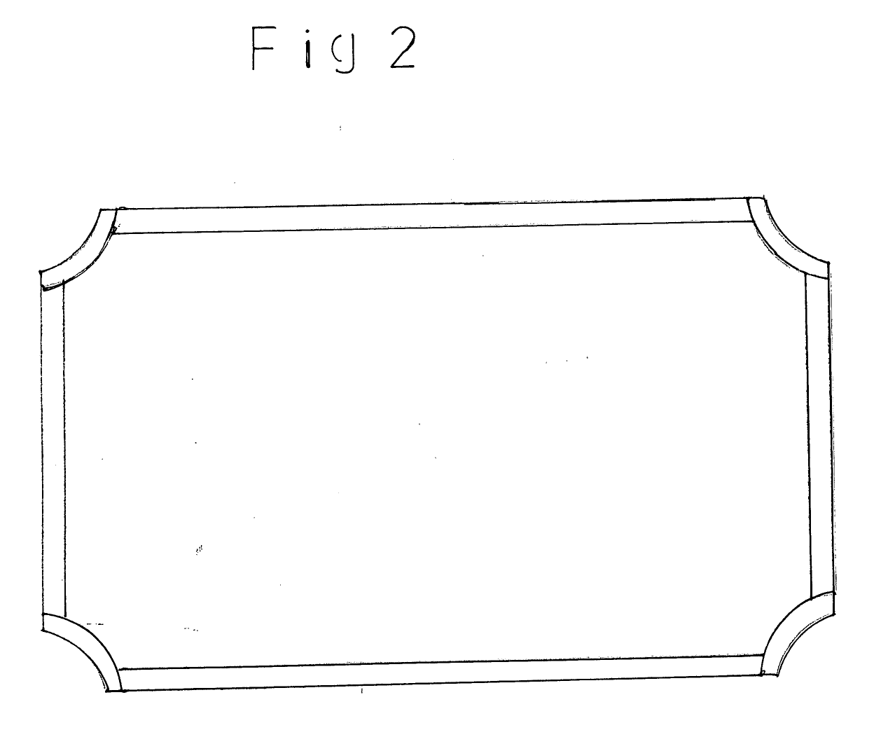

FIG. 2 is a plain view thereof;

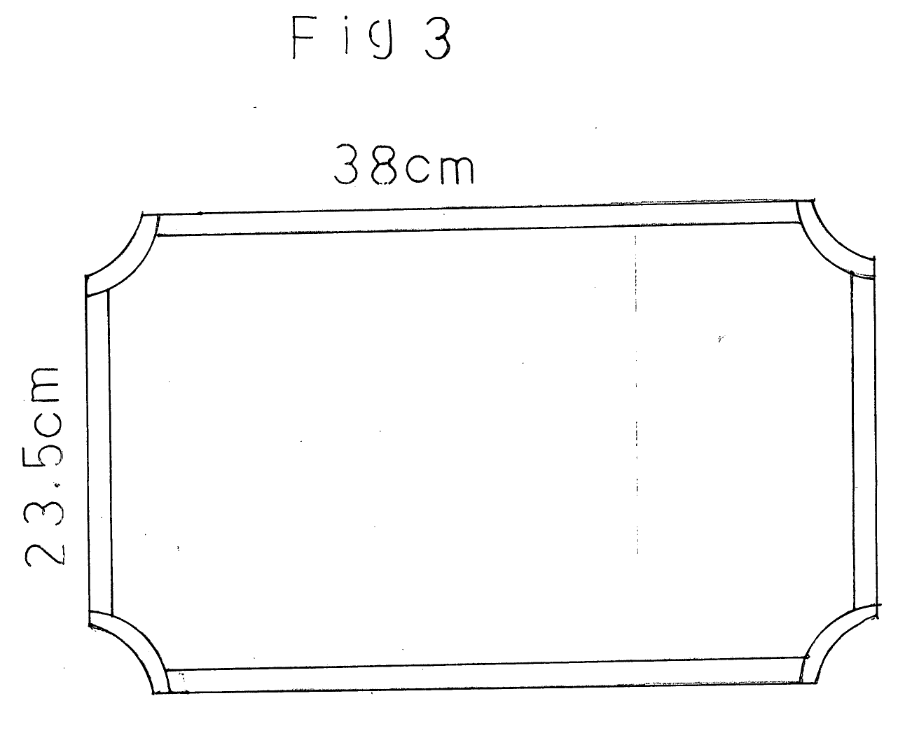

FIG. 3 is a approximate outside dimension view thereof;

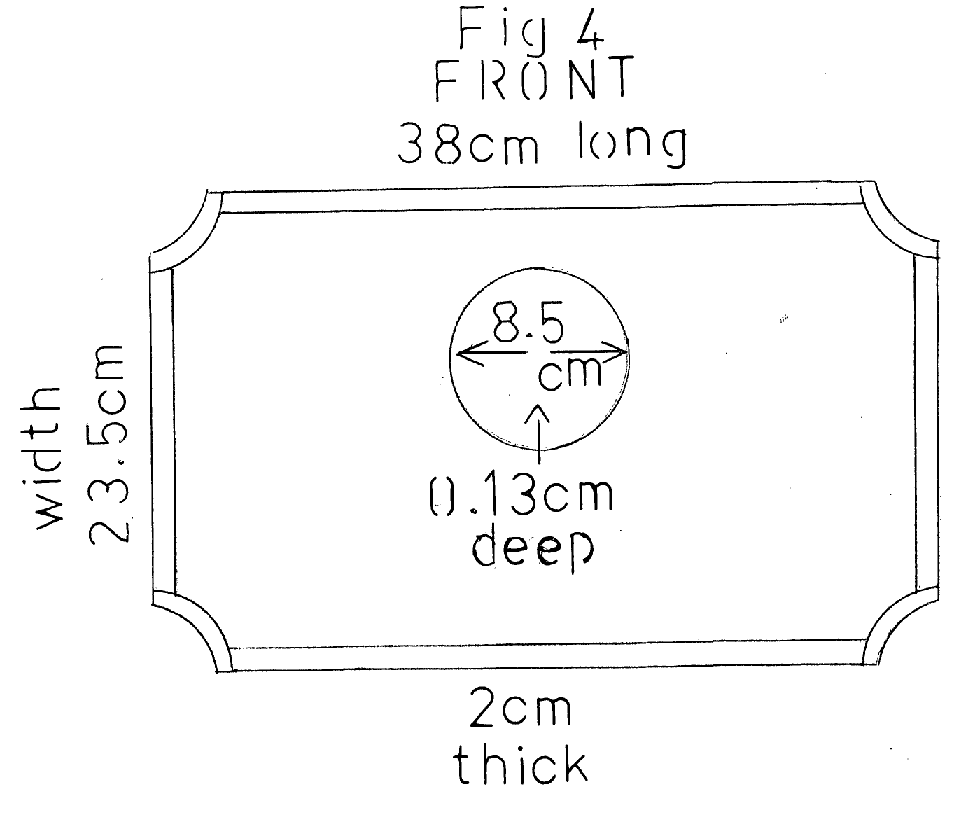

FIG. 4 is of approximate Dimensions of Light Accommodator view thereof;

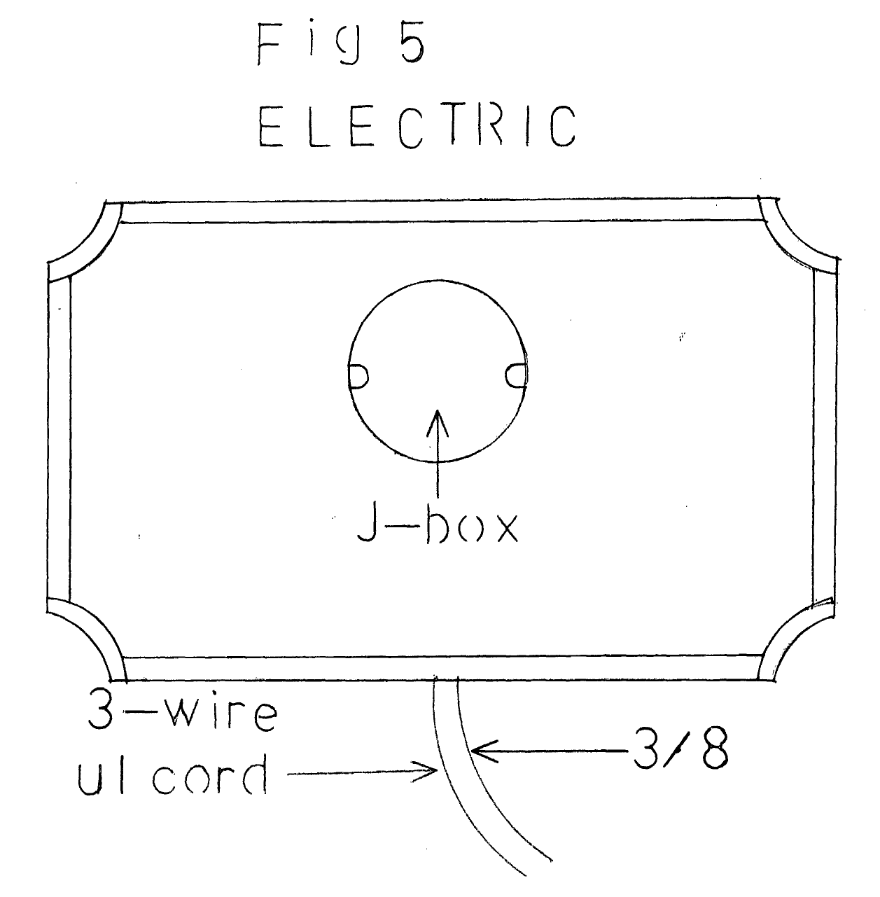

FIG. 5 is of electric components view thereof;

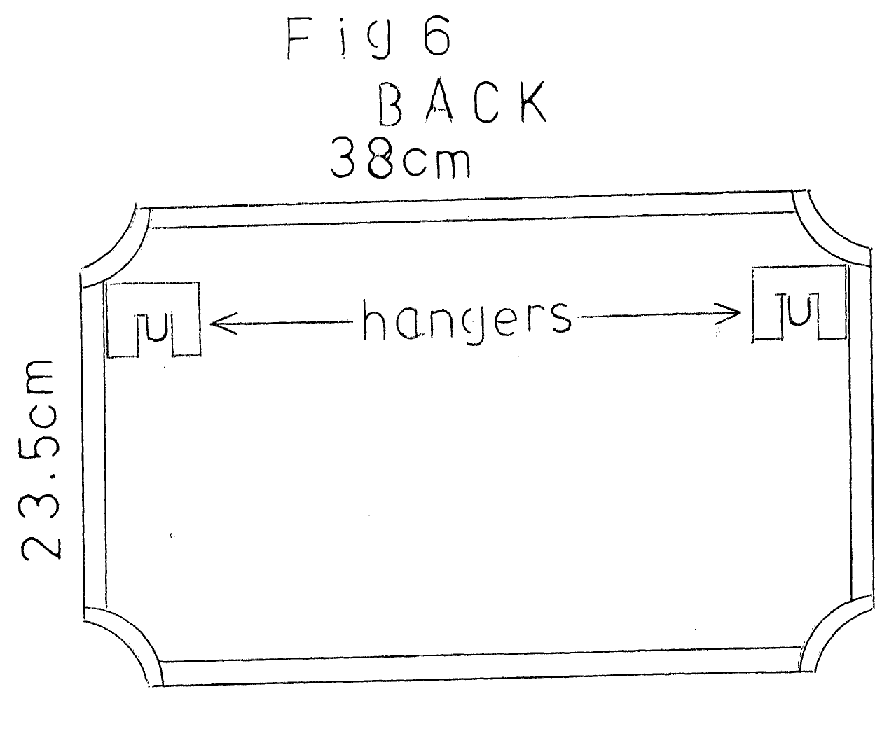

FIG. 6 is a back with slip hook hangers view thereof;

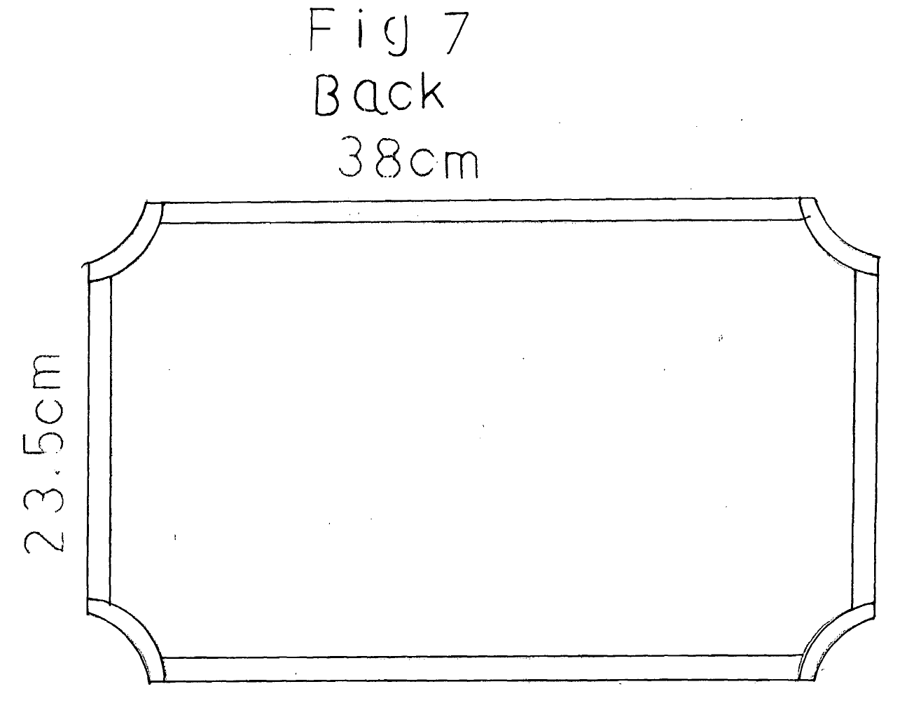

FIG. 7 is a Back view thereof;

1. The ornamental design for a Light Accommodator as shown.
